(19) United States
(12) Patent Application Publication
(10) Pub. No.: US 2011/0223366 A1
(43) Pub. Date: Sep. 15, 2011

(54) Reinforced continuous loop matrix member; continuous loop reinforcement assembly; flexible cylindrical reinforcement band; and axially reinforced cylindrical coil

(76) Inventors: Patrick A. Petri, Greer, SC (US); Kirkland W. Vogt, Simpsonville, SC (US)

(21) Appl. No.: 12/661,196

(22) Filed: Mar. 12, 2010

(51) Int. Cl. B29D 23/00

(52) U.S. Cl. 428/36.5; 428/34.1

(57) ABSTRACT

A continuous loop reinforcement assembly has an inner first flexible cylindrical reinforcement band separated from an outer second flexible cylindrical reinforcement band by a flexible intermediate resilient spacer. The intermediate resilient spacer applies a constant even force to the first and second flexible cylindrical reinforcement bands around the annular space between the two bands. The intermediate resilient spacer is a porous material formed of foam, nonwovens, spacer fabrics, or similar materials. The cylindrical bands are flexible with openings, and are formed from a coil of cable or similar material. The first and second flexible cylindrical reinforcement bands have a Young's Modulus greater than the Young's Modulus of a matrix that encapsulates the cylindrical reinforcement assembly. A retainer uses yarns to secure the cable in the coil. The retainer includes two polymers of different melting points, the lower melting point polymer is melt bonded to secure the retainer fixed around the cables. One of the yarns in the retainer can be a structural reinforcing yarn, and a second yarn in the retainer can be a tying yarn securing the structural yarn to the cable in the coil. A reinforced matrix continuous loop member is formed by passing the matrix through the flexible cylindrical reinforcement members and intermediate resilient spacer of the continuous loop reinforcement assembly to form the member, such as a belt, hose, roller, or tire.

### BACKGROUND

The present invention generally relates to reinforcement assemblies for matrix materials, and more specifically to reinforcement assemblies for continuous loop members with reinforced matrix materials.

### BRIEF DESCRIPTION OF THE DRAWINGS

FIG. 1 is a perspective view of one embodiment of the present invention illustrated as the continuous loop reinforcement assembly 10 having a first flexible cylindrical reinforcement band 100, a intermediate resilient spacer 200, and a second flexible cylindrical reinforcement band 300.

FIG. 2 is a perspective view of the first flexible cylindrical reinforcement band 100 from FIG. 1.

FIGS. 3A and 3B are a partial view of two embodiments of the first flexible cylindrical reinforcement band 100 from FIG. 2.

FIG. 4 is a perspective view of the second flexible cylindrical reinforcement band 300 from FIG. 1.

FIGS. 5A and 5B are a partial view of two embodiments of the second flexible cylindrical reinforcement band 300 from FIG. 4.

FIG. 6 is a perspective view of the intermediate resilient spacer 200 from FIG. 1.

FIG. 7 is a perspective view the continuous loop reinforcement assembly 10 with a break out illustrating another embodiment of the intermediate resilient spacer 200.

FIG. 8 is a perspective view the continuous loop reinforcement assembly 10 with a break out illustrating yet another embodiment of the intermediate resilient spacer 200.

FIG. 9 is a perspective view of another embodiment of the continuous loop reinforcement assembly 10 with the first flexible cylindrical reinforcement band 100, the intermediate resilient spacer 200, and the second flexible cylindrical reinforcement band 300, and further including a second intermediate resilient spacer 400, and a third flexible cylindrical reinforcement band 500.

### DETAILED DESCRIPTION

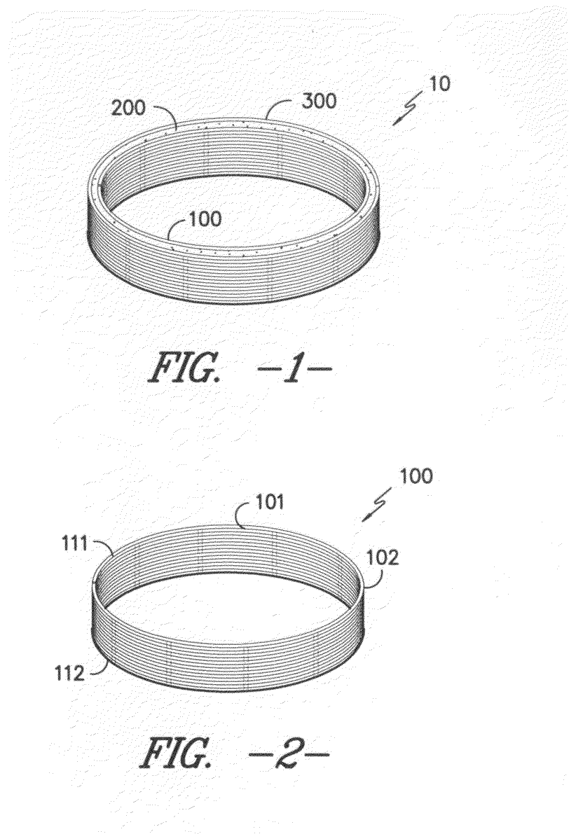

Referring now to FIG. 1, there is shown an embodiment of the present invention illustrated as the continuous loop reinforcement assembly 10. The continuous loop reinforcement assembly 10 provides reinforcement for a matrix material, such as polyurethane or epoxy, in a continuous loop member, such as a belt, hose, wheel, or roller. The continuous loop reinforcement assembly 10 is porous for receiving the matrix material and being embedded within the continuous loop member. The continuous loop reinforcement assembly 10 in the present invention is flexible in the radial direction to provide for distributing radial forces applied to the device reinforced by the continuous loop reinforcement assembly 10. As illustrated in FIG. 1, the continuous loop reinforcement assembly 10 includes a first flexible cylindrical reinforcement band 100, a second flexible cylindrical reinforcement band 300, and a intermediate resilient spacer 200 disposed between the first flexible cylindrical reinforcement band 100 and the second flexible cylindrical reinforcement band 300.

Referring now to FIGS. 1-4, the first flexible cylindrical reinforcement band 100 has a first band inner surface 101 and a first band outer surface 102. The second flexible cylindrical reinforcement band 300 has a second band inner surface 301 and a second band outer surface 302. The intermediate resilient spacer 200 has a spacer inner surface 201 that engages the first band outer surface 102, and a spacer outer surface 202 that engages the second band inner surface 301.

Referring now to FIG. 2, the first flexible cylindrical band 100 is a cylindrical member with flexibility in the radial direction. In a preferred embodiment, the first flexible cylindrical band 100 has a flexibility wherein the first flexible cylindrical band 100 can be subjected to a bend radius that is one-tenth or less of its normal inside diameter in the continuous loop reinforcing assembly 10 without experiencing a permanent set to the material. Because the first flexible cylindrical band 100 is a reinforcing component of the continuous loop reinforcing assembly 10, the Young's Modulus of the material in the first flexible cylindrical band 100 in the tangential direction will be greater than the Young's Modulus of the matrix reinforced by the first cylindrical band 100. In one preferred embodiment, the Young's Modulus of the first flexible cylindrical band 100 is at least 1,000 times greater than the Young's Modulus of the matrix reinforced by the first flexible cylindrical band 100.

In the embodiment illustrated in FIG. 2, the first flexible cylindrical band 100 comprises a continuous band of a coil 110, such as a coil formed from one or more yarns or cables 111 wound into a helix, each cable 111 making at least three revolutions around the first flexible cylindrical band 100. What is meant by a “continuous band” is that the band continues around to itself without the use of a seam across the band. The cables 111 have high longitudinal tension and compression stiffness, and flexibility in the tangential direction. Preferred materials for the cables 111 would include high modulus materials such as metal, steel, carbon, aramid, or glass fibers. Multiple retainers 112 can attach to cable 111 for maintaining the integrity of the coil 110. The retainers 112 can be a polymeric material woven into the cables 111, a metal strip crimped to the cables 111, or the like. The retainers 112 provide an axial stiffness to the first flexible cylindrical band 100 prior to incorporation of the matrix material with the continuous loop reinforcement assembly 10.

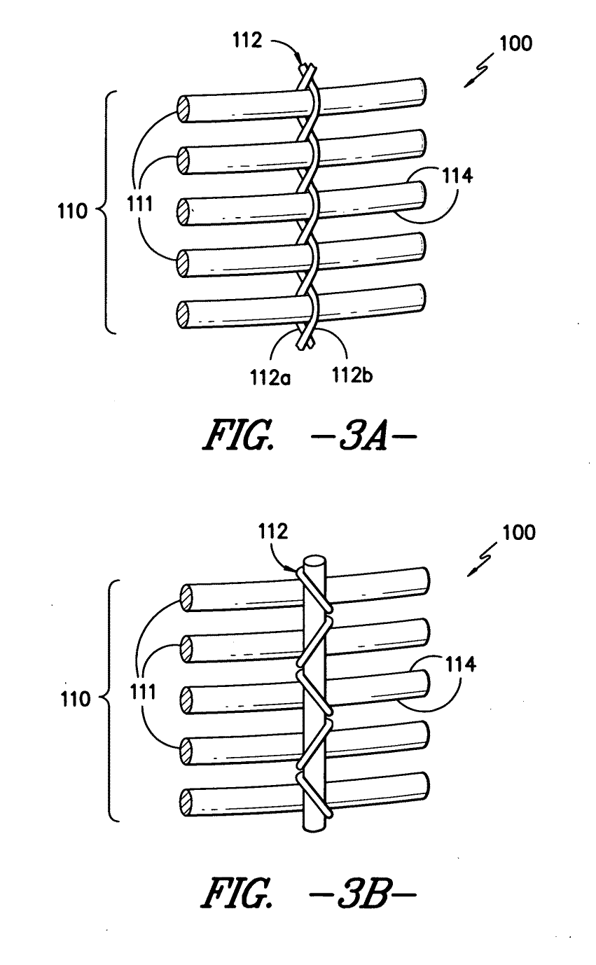

Referring now to FIGS. 3A and 3B, there are shown two embodiments of the first flexible cylindrical band 100 with the retainers 112 comprising reinforcing yarns 112a and 112b. The reinforcing yarns 112a and 112b can be different ends of a single yarn, or two different yarns. The reinforcing yarns 112a and 122b are woven or knitted longitudinally into the coil 110 in between the cables 111. The reinforcing yarns 112a and 112b need to be flexible enough to incorporate into the coil 110, but provide axial stiffness to the first flexible cylindrical reinforcement band 100.

Still referring to FIGS. 3A and 3B, in one preferred embodiment at least one of the reinforcing yarns 112a and 112b comprise polymeric yarn with a higher melt temperature material and a lower melt temperature material. In a preferred embodiment, both of the reinforcing yarns 112a and 112b comprise polymeric yarns with a higher melt temperature material and a lower melt temperature material. Prior to any melt bonding of the two melt temperature materials, the reinforcing yarns 112a and 112b are incorporated into the coil 110. In this manner, the reinforcing yarns 112a and 112b are flexible enough to be incorporated into the coil 110 with minimum difficulty. After the reinforcing yarns are incorporated into the coil 110, the subassembly is subjected to a temperature above the melt temperature of the lower melt temperature material, and below the melt temperature of the higher melt temperature material. After the lower melt temperature material is melted, the temperature is lowered below its melt temperature, melt bonding the lower melt temperature material to the higher temperature material thereby creating a fused reinforcing spacing yarn. By fusing the reinforcing yarns 112a and 112b, the retainer 111 formed by the yarns becomes more rigid. This extra rigidity provides the first flexible cylindrical band with an increased axial stiffness. In order to help maintain axial stability of the first flexible cylindrical reinforcement band 100 through the process of incorporation of the matrix with the continuous loop reinforcement assembly 10, it is preferred that the lower melt temperature material of the reinforcing yarns have a melt temperature above the formation or cure temperature of the matrix.

Referring still to FIGS. 3A and 3B, the reinforcing yarns 112a and 112b using different melt temperature materials can be formed of a fiber or fibers having the materials with the different melting points, such as core/sheath fibers, or can be formed from a combination of fibers having different melting points. The reinforcing yarns 112a and 112b can be monofilament yarns, multifilament yarns, or staple fiber yarns. When selecting yarns for the reinforcing yarns 112a and 112b, attention should be given to selecting yarns that will withstand the friction forces of assembly and any processing of the continuous loop reinforcing assembly 10 prior to incorporation with the matrix, such as washing. It is preferable that the higher melt temperature material of such reinforcing yarns be selected to have sufficient elasticity to reduce the likelihood of assembly problems. It is also preferable that the higher melt temperature material of such reinforcing yarns be selected to have low shrinkage characteristics, particularly when subjected to the heat of fusing the reinforcing yarns and incorporation of the matrix material into the continuous loop reinforcement assembly. In one embodiment the filament or fibers are a core and sheath configuration with the higher melt temperature polymer being the core and the lower melt temperature polymer being the sheath. In another embodiment, the yarn comprises filaments or fibers of the higher melt temperature polymer and separate filaments or fibers of the lower melt temperature polymer.

Still referring to FIGS. 3A and 3B, reinforcing yarn 112a is illustrated as a structural yarn and reinforcing yarn 112b is illustrated as a tie yarn. The structural reinforcing yarn 112a is stiffer and heavier than the tie reinforcing yarn 112b. The structural reinforcing yarn 112a provides axial rigidity to the coil 100. The reinforcing yarn 112a can be secured to the outside or the inside of the coil 110. In one embodiment, the structural reinforcing yarn 112a is a monofilament yarn. The tie reinforcing yarn 112b secures the cables 111 of the coil adjacent to the structural reinforcing yarn 112a. In one embodiment the tie reinforcing yarn 112b includes a lower melt temperature polymer material as described above, and can include a higher melt temperature polymer material as described above. The melt temperature of the lower melt temperature polymer material in the tie yarn is a lower temperature than the primary materials in the structural reinforcing yarn 112a. In this manner, the tie reinforcing yarn 112b can be used to better secure the cables 111 of the coil 110 to the structural reinforcing yarn. When using a tie reinforcing yarn 112b having a polymer with a lower melting temperature, it is preferred that the structural reinforcing yarn 112a have low shrinkage when subject to the melting temperature of the lower melting temperature polymer in the tie reinforcing yarn 112b, such as with a heat set polymer yarn. In one embodiment, the tie reinforcing yarn 112b includes filaments or staple fibers with the lower melt temperature, and filaments or staple fibers of the higher melting temperature. When the tie reinforcing yarn 112b includes filaments or staple fibers of both lower melt temperature and high melt temperature polymer, it is also preferred that the filament with the high melt temperature polymer have some shrink during melting of the lower melt temperature polymer, such as with a yarn that is not heat set, thereby cinching up the connection between the structural reinforcing yarn 112a and the at least one cable 111 of the coil 110.

Referring still to FIGS. 3A and 3B, there are shown two different patterns for the reinforcing yarns 112a and 112b. In FIG. 3A, the reinforcing yarns 112a and 112b secure the cables 111 of the coil 110 with a weave pattern. As illustrated in FIG. 3A, the reinforcing yarns 112a and 112b are woven into the coil 110 in a leno weave, with cross-overs of the yarns occurring between cables. However, the reinforcing yarns 112a and 112b could be incorporated into the coil 110 with other weave patterns. In FIG. 3B, the reinforcing yarns 112a and 112b secure the cables 111 of the coil 110 with a Malimo style stitch knit pattern. However, the reinforcing yarns 112a and 112b could be incorporated into the coil 110 with other knit patterns. Although FIGS. 3A and 3B illustrate the reinforcing yarns 112a and 112b as being incorporated into the coil 110 with a weave or knit pattern, a series of single reinforcing yarns 112 could also be wound through the coil 110.

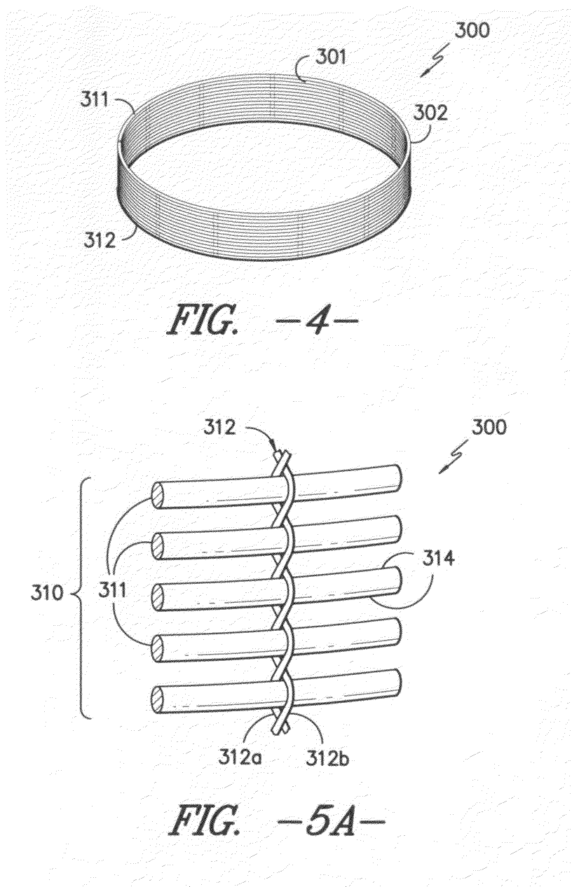

Referring now to FIG. 4, the second flexible cylindrical band 300 is a cylindrical member with flexibility in the radial direction. In a preferred embodiment, the second flexible cylindrical band 300 has a flexibility wherein the second flexible cylindrical band 300 can be subjected to a bend radius that is one-tenth or less of its normal inside diameter in the continuous loop reinforcing assembly 10 without experiencing a permanent set to the material. Because the second flexible cylindrical band 300 is a reinforcing component of the continuous loop reinforcing assembly 10, the Young's Modulus of the material in the second flexible cylindrical band 300 in the tangential direction will be greater than the Young's Modulus of the matrix reinforced by the second flexible cylindrical band 300. In one preferred embodiment, the Young's Modulus of the second flexible cylindrical band 300 is at least 1,000 times greater than the Young's Modulus of the matrix reinforced by the second flexible cylindrical band 300.

In the embodiment illustrated in FIG. 4, the second flexible cylindrical band 300 comprises a continuous band of a coil 310, such as a coil formed from one or more cables 311 wound into a helix, each cable 310 making at least three revolutions around the second flexible cylindrical band 300. What is meant by a “continuous band” is that the band continues around to itself without the use of a seam across the band. The cables 311 have high longitudinal tension and compression stiffness, and flexibility in tangential direction. Preferred materials for the cables 311 would include high modulus materials such as metal, steel, carbon, aramid, or glass fibers. Multiple retainers 312 can attach to cable 311 for maintaining the integrity of the coil 310. Retainers 312 can be a polymeric material woven into the cables 311, a metal strip crimped to the cables 311, or the like. The retainers 312 provide an axial stiffness to the second flexible cylindrical band 300 prior to incorporation of the matrix material with the continuous loop reinforcement assembly 10.

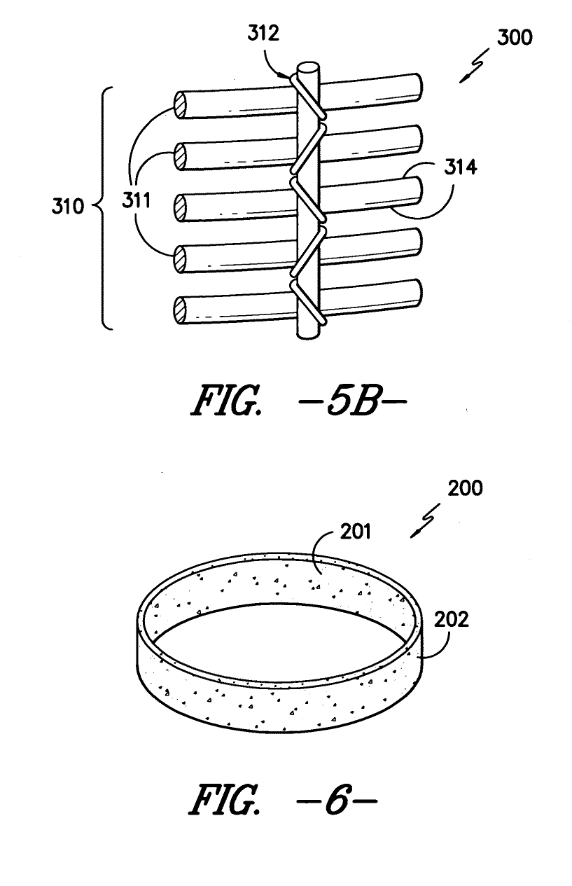

Referring now to FIGS. 5A and 5B, there are shown two embodiment of the second flexible cylindrical band 300 with the retainers 312 comprising reinforcing yarns 312a and 312b. The reinforcing yarns 312a and 312b can be different ends of a single yarn, or two different yarns. The reinforcing yarns 312a and 312b are woven longitudinally into the coil 310 in between the cables 311. The reinforcing yarns 312a and 312b need to be flexible enough to incorporate into the coil 310, but provide axial stiffness to the second flexible cylindrical reinforcement band 300.

Still referring to FIGS. 5A and 5B, in one preferred embodiment at least one of the reinforcing yarns 312a and 312b comprise polymeric yarn with a higher melt temperature material and a lower melt temperature material. In a preferred embodiment, both of the reinforcing yarns 312a and 312b comprise polymeric yarns with a higher melt temperature material and a lower melt temperature material. Prior to any melt bonding of the two melt temperature materials, the reinforcing yarns 312a and 312b are incorporated into the coil 310. In this manner, the reinforcing yarns 312a and 312b are flexible enough to be incorporated into the coil 310 with minimum difficulty. After the reinforcing yarns are incorporated into the coil 310, the subassembly is subjected to a temperature above the melt temperature of the lower melt temperature material, and below the melt temperature of the higher melt temperature material. After the lower melt temperature material is melted, the temperature is lowered below its melt temperature, melt bonding the lower melt temperature material to the higher temperature material thereby creating a fused reinforcing spacing yarn. By fusing the reinforcing yarns 312a and 312b, the retainer 311 formed by the yarns becomes more rigid. This extra rigidity provides the first flexible cylindrical band with an increased axial stiffness. In order to help maintain axial stability of the second flexible cylindrical reinforcement band 300 through the process of incorporation of the matrix with the continuous loop reinforcement assembly 10, it is preferred that the lower melt temperature material of the reinforcing yarns have a melt temperature above the formation or cure temperature of the matrix.

Referring still to FIGS. 5A and 5B, the reinforcing yarns 312a and 312b using different melt temperature materials can be formed of a fiber or fibers having the materials with the different melting points, such as core/sheath fibers, or can be formed from a combination of fibers having different melting points. The reinforcing yarns 312a and 312b can be monofilament yarns, multifilament yarns, or staple yarns. When selecting yarns for the reinforcing yarns 312a and 312b, attention should be given to selecting yarns that will withstand the friction forces of assembly and any processing of the continuous loop reinforcing assembly 10 prior to incorporation with the matrix, such washing. It is preferable that the higher melt temperature material of such reinforcing yarns be selected to have sufficient elasticity to reduce the likelihood of assembly problems. It is also preferable that the higher melt temperature material of such reinforcing yarns be selected to have low shrinkage characteristics, particularly when subjected to the heat of fusing the reinforcing yarns and incorporation of the matrix material into the continuous loop reinforcement assembly. In one embodiment the filament or fibers are a core and sheath configuration with the higher melt temperature polymer being the core and the lower melt temperature polymer being the sheath. In another embodiment, the yarn comprises filaments or fibers of the higher melt temperature polymer and separate filaments or fibers of the lower melt temperature polymer.

Still referring to FIGS. 5A and 5B, reinforcing yarn 312a is illustrated as a structural yarn and reinforcing yarn 312b is illustrated as a tie yarn. The structural reinforcing yarn 312a is stiffer and heavier than the tie reinforcing yarn 312b. The structural reinforcing yarn 312a provides axial rigidity to the coil 300. The reinforcing yarn 312a can be secured to the outside or the inside of the coil 310. In one embodiment, the structural reinforcing yarn 312a is a monofilament yarn. The tie reinforcing yarn 312b secures the cables 311 of the coil adjacent to the structural reinforcing yarn 312a. In one embodiment the tie reinforcing yarn 312b includes a lower melt temperature polymer material as described above, and can include a higher melt temperature polymer material as described above. The melt temperature of the lower melt temperature polymer material in the tie yarn is a lower temperature than the primary materials in the structural reinforcing yarn 312a. In this manner, the tie reinforcing yarn 312b can be used to better secure the cables 311 of the coil 310 to the structural reinforcing yarn. When using a tie reinforcing yarn 312b having a polymer with a lower melting temperature, it is preferred that the structural reinforcing yarn 312a have low shrinkage when subject to the melting temperature of the lower melting temperature polymer in the tie reinforcing yarn 312b, such as with a heat set polymer yarn. In one embodiment, the tie reinforcing yarn 312b includes filaments or staple fibers with the lower melt temperature, and filaments or staple fibers of the higher melting temperature. When the tie reinforcing yarn 312b includes filaments or staple fibers of both lower melt temperature and high melt temperature polymer, it is also preferred that the filament with the high melt temperature polymer have some shrink during melting of the lower melt temperature polymer, such as with a yarn that is not heat set, thereby cinching up the connection between the structural reinforcing yarn 312a and the at least one cable 311 of the coil 310.

Referring still to FIGS. 5A and 5B, there are shown two different patterns for the reinforcing yarns 312a and 312b. In FIG. 5A, the reinforcing yarns 312a and 312b secure the cables 311 of the coil 310 with a weave pattern. As illustrated in FIG. 5A, the reinforcing yarns 312a and 312b are woven into the coil 310 in a leno weave, with cross-overs of the yarns occurring between cables. However, the reinforcing yarns 312a and 312b could be incorporated into the coil 310 with other weave patterns. In FIG. 5B, the reinforcing yarns 312a and 312b secure the cables 311 of the coil 310 with a Malimo style stitch knit pattern. However, the reinforcing yarns 312a and 312b could be incorporated into the coil 310 with other knit patterns. Although FIGS. 5A and 5B illustrate the reinforcing yarns 312a and 312b as being incorporated into the coil 310 with a weave or knit pattern, a series of single reinforcing yarns 312 could also be wound through the coil 310.

Referring now to FIGS. 1-6, the intermediate resilient spacer 200 is a resilient material that applies a constant pressure to the first band outer surface 102 and the second band inner surface 301. What is meant by resilient is that the resilient spacer generates increasing reaction forces with increasing amounts of compression. The thickness of the intermediate resilient spacer 200 in the radial direction is greater than the space created between the first flexible cylindrical reinforcement band 100 and the second flexible cylindrical reinforcement band 300 in the radial direction. In this manner, the intermediate resilient spacer 200 exerts constant pressure between the two flexible cylindrical reinforcement bands 100, 300, around the continuous loop reinforcement assembly 10. To help create a uniform pressure around the continuous loop reinforcement assembly 10, the intermediate resilient spacer 200 preferably has a substantially uniform thickness and is substantially uniform in composition. This constant even pressure maintains the spatial relationship between the first flexible cylindrical band 100 and the second flexible cylindrical reinforcement band 300. The even pressure between the first flexible cylindrical reinforcement band 100 and the second flexible cylindrical reinforcement band 300 creates a force equilibrium that will maintain centering of the two bands even if there are variations in the diameter of the first or second flexible cylindrical bands 100, 300. In designing the intermediate resilient spacer 200, caution must be exercised to prevent excessive pressure on the first flexible cylindrical reinforcement band 100. When the intermediate resilient spacer 200 exerts excessive pressure on the first flexible cylindrical reinforcement band 100, the first flexible cylindrical reinforcement band 100 will buckle deforming the shape. In one embodiment, the intermediate resilient spacer 200 can elastically recover from at least 30% compression. In another embodiment, the materials forming the intermediate resilient spacer 200 can elastically recover from greater than an 80% compression.

Preferably, the intermediate resilient spacer 200 holds itself and the two reinforcing bands 100, 300, in place without additional fixation. Typically, the normal pressure and resulting friction between the intermediate resilient spacer 200 and the two reinforcing bands 100, 300, is sufficient to stabilize the continuous loop reinforcement assembly 10, even during incorporation of the matrix material when forming a cylindrical member. When the intermediate resilient spacer 200 exerts a pressure between the two flexible cylindrical reinforcing bands 100, 300, it also creates a bulge of the spacer material between the cables 111, 311. This bulge between the cables 111, 311, results in further stabilization of the continuous loop reinforcing assembly 10 and helps stabilize the position of the individual cables 111, 311, within the flexible cylindrical reinforcing bands 100, 300, respectively. In other embodiments, the intermediate resilient spacer 200 can use a material with very small protrusions or arms that hold the cables 111, 311, thereby stabilizing the position of the individual cables 111, 311, within the cylindrical reinforcing bands 100, 300, respectively. The stabilization of the reinforcing bands 100, 300, and the intermediate resilient spacer 200 can be improved with adhesives and material geometry that provides a gripping effect between the intermediate resilient spacer 200 and the flexible cylindrical reinforcing bands 100, 300. Increased friction, adhesion, or gripping between the intermediate resilient spacer 200 and the first flexible cylindrical reinforcing band 100 will also increase the pressure that can be exerted by the intermediate resilient spacer 200 to the first flexible cylindrical reinforcing band 100 before the onset of buckling of the first flexible cylindrical reinforcing band 100.

In addition to providing a spring like constant pressure between the two reinforcement bands 200, 300, the intermediate resilient spacer 200 is also porous for receiving the matrix material that is reinforced. Preferably, the intermediate resilient spacer 200 is porous without closed voids or torturous flow paths that reverse flow direction or create dead end flows. A porous material will include voids reducing the volume of the mass making up the porous material. It is preferable to increase the void area in a porous material by reducing the volume of the mass in a porous material to the minimum practical amount. As an example, the volume of the mass forming the porous material may have a maximum volume of fifteen percent (15%). In a preferred embodiment, the volume of the mass forming the porous material has a maximum volume of five percent (5%). Additionally, in one preferred embodiment, the intermediate resilient spacer 200 comprises the same material as in the matrix, such as polyurethane.

In a preferred embodiment of the present invention, the intermediate resilient spacer 200 is a flexible member. Flexing of the intermediate resilient spacer 200 facilitates the assembly of the continuous loop reinforcement assembly 10, and allows the final reinforced matrix member to flex without functional damage to the components of continuous loop reinforcement assembly 10 or the matrix. Similar to the first flexible cylindrical reinforcement band 100 and the second flexible cylindrical reinforcement band 300, it is preferable that the intermediate resilient spacer 200 as a flexibility wherein the intermediate resilient spacer 200 can be subjected to a bend radius that is one-tenth or less of its normal inside diameter in the continuous loop reinforcement assembly 10 without experiencing a permanent set to the material. In another preferred embodiment, the intermediate spacer 200 has a greater flexibility than the cylindrical reinforcement bands that it engages.

In one embodiment, the intermediate resilient spacer 200 can be a strip of material that is cut to the desired thickness, width, and length, and then inserted between the first reinforcement band 100 and the second reinforcement band 300. In one embodiment, the ends of the strip of material are attached to form the intermediate resilient spacer 200. In another embodiment, the strip of material placed between the first reinforcement band 100 and the second reinforcement band 300 as the intermediate resilient spacer 200, is a strip of material that is not attached at the ends with the ends loosely abutting each other. In some instances, it may be acceptable to have a small gap between the ends of a material forming the intermediate resilient spacer 200. Also, the axial width of the intermediate resilient spacer 200 does not always need to equal the full width of the reinforcement bands 100 or 300.

In one embodiment, the intermediate resilient spacer 200 is a foam material. In order to provide a spacer with the porous characteristics, the foam material can be an open cell foam material. In particular, a reticulated foam material provides a porous resilient material for the intermediate resilient spacer 200. In reticulated foam, cell walls are removed by methods such as passing a controlled flame or chemical etching fluid through the medium. The remaining material of the reticulated foam can also provide arms that secure the cables 111, 311, within the cylindrical reinforcing bands 100, 300. In addition, the foam material can be the same material as the matrix to be reinforced. For example, polyurethane foam can be used as the intermediate resilient spacer 200 in a cylindrical reinforcing member 10 to reinforce a polyurethane matrix.

In yet another embodiment, the intermediate resilient spacer 200 is a nonwoven material. One type of nonwoven material that could be used as the spacer is a nonwoven material with thick filaments which are formed into a three-dimensional shape, such as a two or three dimensional corrugated configuration. Nonwovens with thickness oriented, or “z” oriented, fibers can provide resilient properties to the nonwoven.

In yet even another embodiment, the intermediate resilient spacer 200 is a spacer fabric. A spacer fabric is a knit or woven fabric that has two face layers separated by fibers or yarns extending between the two layers. The fibers between the two layers provide a spring-like force that opposes the compression of the spacer fabric. Considerations for the spacer fabric would be openness, pore shape, pore size, stiffness, direction of the separating fiber or yarn, ability of material to adhere to the matrix material, and the like.

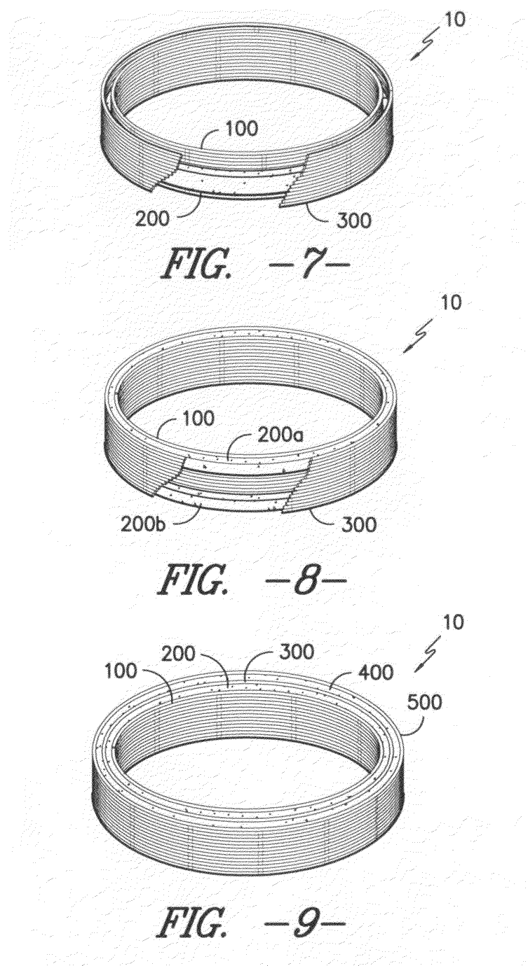

Referring now to FIG. 7, there is shown an embodiment of the present invention with the intermediate resilient spacer 200 having a width smaller than the width of the first cylindrical reinforcement band 100 or the second cylindrical reinforcement band 300. In this embodiment, the intermediate resilient spacer 200 is centered in the width direction of the continuous loop reinforcement assembly 10. The flexible cylindrical reinforcement bands 100, 300, are designed to maintain a constant spatial relationship between each other at widths beyond the intermediate resilient spacer 200.

Referring now to FIG. 8, there is shown an embodiment of the present invention with the first flexible cylindrical reinforcement band 100 and the second flexible cylindrical reinforcement band 300 being spaced apart by two intermediate resilient spacers 200a and 200b. In this embodiment, the intermediate resilient spacers 200a and 200b are narrower than the flexible cylindrical reinforcement bands 100, 300, and are disposed towards opposing outer edges of the flexible cylindrical reinforcement bands 100, 300. By splitting the intermediate resilient spacer into two bands disposed at the outer edges of the flexible cylindrical reinforcement members 100, 300, the continuous loop reinforcement assembly 10 will have better resistance to out of plane rotational disturbances.

Referring now to FIG. 9, there is shown an embodiment of the present invention where a third flexible cylindrical reinforcement band 500 is disposed outside of the second flexible cylindrical reinforcement band 300, and a second intermediate resilient spacer 400 is disposed between the second flexible cylindrical reinforcement band 300 and the third cylindrical reinforcement band 500. The third flexible cylindrical reinforcement band 500 has the same properties and characteristics as the first flexible cylindrical reinforcement band 100 or the second flexible reinforcement band 300. The second intermediate resilient spacer 400 also has the same properties and characteristics as the intermediate flexible resilient spacer 200. It is contemplated that the cylindrical reinforcement assembly of the present invention could have multiple layers of cylindrical reinforcement bands separated by one or more intermediate resilient layers.

Although the present invention has been described in considerable detail with reference to certain preferred versions thereof, other versions are possible. Therefore, the spirit and scope of the appended claims should not be limited to the description of the preferred versions contained herein.

What is claimed is:

1. A continuous loop reinforced matrix member comprising:
a matrix material;
a continuous loop reinforcing assembly disposed within said matrix material, the reinforcing assembly including:
a first flexible cylindrical reinforcement band having an outer surface;
a second flexible cylindrical reinforcement band disposed around the first flexible cylindrical reinforcement band, the second flexible cylindrical reinforcement band having an inner surface facing towards the first flexible cylindrical reinforcement band;
a porous resilient spacer disposed between the first flexible cylindrical reinforcement band and the second flexible cylindrical reinforcement band, wherein the porous resilient spacer contacts the outer surface of the first flexible cylindrical reinforcement band and the inner surface of the second flexible cylindrical reinforcement band;
wherein the first flexible cylindrical reinforcement band and the second flexible cylindrical band have a Young's Modulus greater than the matrix material.

2. The continuous loop reinforced matrix member assembly according to claim 1, wherein the first flexible cylindrical reinforcement band comprises at least one cable wound in a helix, the at least one cable making at least three revolutions around the first flexible cylindrical reinforcement band.

3. The continuous loop reinforced matrix member according to claim 1, wherein the second flexible cylindrical reinforcement band comprises at least one cable wound in a helix, the at least one cable making at least three revolutions around the second flexible cylindrical reinforcement band.

4. The continuous loop reinforced matrix member according to claim 1, wherein the porous resilient spacer comprises a strip of material.

5. The continuous loop reinforced matrix member assembly according to claim 1, wherein the porous resilient spacer comprises a foam material.

6. The continuous loop reinforced matrix member according to claim 1, wherein the porous resilient spacer and the matrix comprise the same material.

7. The continuous loop reinforced matrix member assembly according to claim 6, wherein the porous resilient spacer and the matrix comprise polyurethane.

8. The continuous loop reinforced matrix member according to claim 1, wherein:
the first flexible cylindrical reinforcement band comprises at least one first cable wound in a helix, the at least one first cable making at least three revolutions around the first flexible cylindrical reinforcement band,
the second flexible cylindrical reinforcement band comprises at least one second cable wound in a helix, the at least one second cable making at least three revolutions around the first flexible cylindrical reinforcement band,
wherein the porous resilient spacer comprises a foam material, and wherein the matrix material and the porous resilient spacer comprise the same material.

9. A continuous loop reinforcing assembly comprising:
a first flexible cylindrical reinforcement band having an outer surface;
a second flexible cylindrical reinforcement band disposed around the first flexible cylindrical reinforcement band, the second flexible cylindrical reinforcement band having an inner surface facing towards the first flexible cylindrical reinforcement band;
a porous resilient spacer disposed between the first flexible cylindrical reinforcement band and the second flexible cylindrical reinforcement band, wherein the porous resilient spacer applies a force to the outer surface of the first flexible cylindrical reinforcement band and to the inner surface of the second flexible cylindrical reinforcement band.

10. The continuous loop reinforcing assembly according to claim 9, wherein the first flexible cylindrical reinforcement band includes openings around the circumference.

11. The continuous loop reinforcing assembly according to claim 9, wherein the second flexible cylindrical reinforcement band includes openings around the circumference.

12. The continuous loop reinforcing assembly according to claim 9, wherein the first flexible cylindrical reinforcement band comprises a cable wound in a helix, the cable making at least three revolutions around the first flexible cylindrical reinforcement band.

13. The continuous loop reinforcing assembly according to claim 12, wherein the first flexible cylindrical reinforcement band further includes at least one retainer securing the cable.

14. The continuous loop reinforcing assembly according to claim 13, wherein the retainer is selected from the group consisting of a polymeric material woven into the cable and a metal strip crimped to the at least one cable.

15. The continuous loop reinforcing assembly according to claim 9, wherein the first flexible cylindrical reinforcement band comprises two or more cables wound in a helix, each of the two or more cables making at least three revolutions around the first flexible cylindrical reinforcement band.

16. The continuous loop reinforcing assembly according to claim 15, wherein the first flexible cylindrical reinforcement band further comprises at least one retainer securing the cables.

17. The continuous loop reinforcing assembly according to claim 16, wherein the retainer is selected from the group consisting of a polymeric material woven into the at least one cable and a metal strip crimped to the at least one cable.

18. The continuous loop reinforcing assembly according to claim 9, wherein the second flexible cylindrical reinforcement band includes a cable wound in a helix, the cable making at least three revolutions around the second flexible cylindrical reinforcement band.

19. The continuous loop reinforcing assembly according to claim 18, wherein the second flexible cylindrical reinforcement band further comprises at least one retainer securing the cable.

20. The continuous loop reinforcing assembly according to claim 19, wherein the retainer is selected from the group consisting of a polymeric material woven into the cable and a metal strip crimped to the at least one cable.

21. The continuous loop reinforcing assembly according to claim 9, wherein the second flexible cylindrical reinforcement band comprises two or more cables wound in a helix, each of the two or more cables making at least three revolutions around the second flexible cylindrical reinforcement band.

22. The continuous loop reinforcing assembly according to claim 21, wherein the second flexible cylindrical reinforcement band further comprises at least one retainer securing the cables.

23. The continuous loop reinforcing assembly according to claim 22, wherein the retainer is selected from the group consisting of a polymeric material woven into the at least one cable and a metal strip crimped to the at least one cable.

24. The continuous loop reinforcing assembly according to claim 9, wherein the first cylindrical reinforcement band can conform to a bend radius that is one-tenth or less of the normal inside diameter of the first cylindrical reinforcement band in the cylindrical reinforcement assembly without experiencing a permanent set.

25. The continuous loop reinforcing assembly according to claim 9, wherein the second cylindrical reinforcement band can conform to a bend radius that is one-tenth or less of the normal inside diameter of the second cylindrical reinforcement band in the cylindrical reinforcement assembly without experiencing a permanent set.

26. The continuous loop reinforcing assembly according to claim 9, further including an adhesive between the porous resilient spacer and the first flexible cylindrical reinforcement band.

27. The continuous loop reinforcing assembly according to claim 9, wherein the porous resilient spacer includes a surface geometry that enhances the grip with the outer surface of the first flexible reinforcing band.

28. The continuous loop reinforcing assembly according to claim 9, wherein the volume of mass making up the porous resilient spacer is less than fifteen percent (15%) of the volume of the porous resilient spacer.

29. The continuous loop reinforcing assembly according to claim 9, wherein the volume of mass making up the porous resilient spacer is less than five percent (5%) of the volume of the porous resilient spacer.

29. The continuous loop reinforcing assembly according to claim 9, wherein the porous resilient spacer can conform to a bend radius that is one-tenth or less of the normal inside diameter of the porous resilient spacer in the cylindrical reinforcement assembly without experiencing a permanent set.

30. The continuous loop reinforcing assembly according to claim 9, wherein the porous resilient spacer has a greater flexibility than the first flexible cylindrical reinforcing band or the second flexible reinforcing band.

31. The continuous loop reinforcing assembly according to claim 9, wherein the porous resilient spacer is a strip of material.

32. The continuous loop reinforcing assembly according to claim 9, wherein the porous resilient spacer is a foam material.

33. The continuous loop reinforcing assembly according to claim 9, wherein the porous resilient spacer is a reticulated foam material.

34. The continuous loop reinforcing assembly according to claim 9, wherein the porous resilient spacer is a nonwoven material.

35. The continuous loop reinforcing assembly according to claim 9, wherein the porous resilient spacer is a spacer fabric.

36. The continuous loop reinforcing assembly according to claim 9, wherein the porous resilient spacer has a width less than the first flexible cylindrical reinforcement band or the second flexible cylindrical band.

37. The continuous loop reinforcing assembly according to claim 9, further including a second porous resilient spacer, wherein the porous resilient spacers are positioned adjacent to the outside edges of the first flexible cylindrical reinforcement band and the second flexible cylindrical band.

38. The continuous loop reinforcing assembly according to claim 9, further including a third flexible cylindrical reinforcement band having an inner surface facing towards an outer surface of the second cylindrical reinforcement band, and a second porous resilient spacer disposed between the third flexible cylindrical reinforcement band and the second reinforcement band, the second porous resilient spacer applying a force to the outer surface of the second flexible cylindrical reinforcement band and to the inner surface of the third flexible cylindrical reinforcement band.

39. A flexible cylindrical reinforcement band comprising:
a continuous band having a coil of at least one cable making at least three revolutions around the coil; and
a plurality of retainers securing the at least one cable, said retainers comprising at least one securing yarn having:
a first material with a first melting point;
a second material with a second melting point, the second melting point being higher than the first melting point; and,
wherein said first material has melt bonded to the second material.

40. The flexible cylindrical reinforcement band according to claim 39, wherein the yarn in said retainers is woven into the coil of the continuous band.

41. The flexible cylindrical reinforcement band according to claim 40, wherein the yarn in said retainers is woven into the coil of the continuous band in a leno weave pattern.

42. The flexible cylindrical reinforcement band according to claim 39, wherein the yarn in said retainers is knitted into the coil of the continuous band.

43. The flexible cylindrical reinforcement band according to claim 39, wherein said retainers contain a second yarn.

44. The flexible cylindrical reinforcement band according to claim 43, wherein said second yarn includes a first material with a first melting point and a second material with a second melting point, the second melting point being higher than the first melting point, and wherein said first material has melt bonded to the second material.

45. The flexible cylindrical reinforcement band according to claim 39, wherein the yarn in said retainers comprise a monofilament yarn.

46. The flexible cylindrical reinforcement band according to claim 45, wherein the monofilament yarn in said retainers comprise a core-sheath yarn, and
wherein the sheath comprises the first material with the first melting point and the core comprises the second material with the second melting point.

47. The flexible cylindrical reinforcement band according to claim 39, wherein the yarn in said retainers comprise a multifilament yarn.

48. The flexible cylindrical reinforcement band according to claim 47, wherein the multifilament yarn in said retainers comprise core-sheath filaments, and wherein the sheath comprises the first material with the first melting point and the core comprises the second material with the second melting point.

49. The flexible cylindrical reinforcement band according to claim 47, wherein the multifilament yarn in said retainers comprise filaments including the first material with the first melting point and filaments including the second material with the second melting point.

50. The flexible cylindrical reinforcement band according to claim 39, wherein the yarn in said retainers comprise a staple yarn having fibers.

51. The flexible cylindrical reinforcement band according to claim 50, wherein the staple yarn in said retainers comprise core-sheath fibers, and wherein the sheath comprises the first material with the first melting point and the core comprises the second material with the second melting point.

52. The flexible cylindrical reinforcement band according to claim 50, wherein the staple yarn in said retainers comprise fibers including the first material with the first melting point and fibers including the second material with the second melting point.

53. An axially reinforced cylindrical coil:
a coil of at least one cable making at least three revolutions around the coil; and
a plurality of axially extending reinforcing members, each reinforcing member including:
a structural reinforcing yarn adjacent to the coil, and
a tying reinforcing yarn securing the structural reinforcing yarn to the at least one cable in the coil.

54. The axially reinforced cylindrical coil according to claim 53, wherein the tying reinforcing yarn comprises a first polymer with a first melt temperature polymer and a second polymer with a second melt temperature higher than the first melt temperature.

55. The axially reinforced cylindrical coil according to claim 53, wherein the tying reinforcing yarn is a staple yarn formed of staple fibers.

56. The axially reinforced cylindrical coil according to claim 55, wherein the tying reinforcing yarn comprises a first polymer with a first melt temperature polymer and a second polymer with a second melt temperature higher than the first melt temperature.

57. The axially reinforced cylindrical coil according to claim 56, wherein the first polymer and second polymer are different fibers in the tying reinforcing yarn.

58. The axially reinforced cylindrical coil according to claim 56, wherein staple yarns includes core sheath staple fibers with the core comprising the second polymer and the sheath comprising the first polymer.

59. The axially reinforced cylindrical coil according to claim 53, wherein the tying reinforcing yarn is a multifilament yarn.

60. The axially reinforced cylindrical coil according to claim 59, wherein the tying reinforcing yarn comprises a first polymer with a first melt temperature polymer and a second polymer with a second melt temperature higher than the first melt temperature.

61. The axially reinforced cylindrical coil according to claim 60, wherein the first polymer and second polymer are different filaments in the tying reinforcing yarn.

62. The axially reinforced cylindrical coil according to claim 61, wherein multifilament yarns included core sheath filaments with the core comprising the second polymer and the sheath comprising the first polymer.

63. The axially reinforced cylindrical coil according to claim 53, wherein the structural reinforcing yarn comprises a monofilament yarn.

64. The axially reinforced cylindrical coil according to claim 63, wherein the monofilament yarn comprises a heat set polymer yarn.

65. The axially reinforced cylindrical coil according to claim 63, wherein the monofilament yarn comprises a sheath including a first polymer with a first melt temperature polymer and core including a second polymer with a second melt temperature higher than the first melt temperature.

66. The axially reinforced cylindrical coil according to claim 53, wherein the tying reinforcement yarn is woven around the structural reinforcement yarn and the at least one cable.

67. The axially reinforced cylindrical coil according to claim 53, wherein the tying reinforcement yarn is woven around the structural reinforcement yarn and the at least one cable in a leno weave pattern.

68. The axially reinforced cylindrical coil according to claim 53, wherein the tying reinforcement yarn is knitted around the structural reinforcement yarn and the at least one cable.
